(19) United States
(12) Patent Application Publication
(10) Pub. No.: US 2005/0266924 A1
(43) Pub. Date: Dec. 1, 2005

(54) Display apparatus and display method

(75) Inventor: Kenichi Horikoshi, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/137,795

(22) Filed: May 26, 2005

(30) Foreign Application Priority Data
May 28, 2004 (JP) 2004-159497

(51) Int. Cl. H04N 5/268

(52) U.S. Cl. 463/40

(57) ABSTRACT

A display apparatus includes an input unit which inputs a video signal, a tuner section which tunes and demodulates a broadcasting signal to output the video signal, an arithmetic processing unit which performs digital arithmetic processing to the video signal from the input unit or the tuner and outputs the processed video signal, a bypass switching unit which outputs the video signal to a subsequent stage without performing the digital arithmetic processing of the arithmetic processing unit, and a display unit which displays a picture on the basis of one of the processed video signal from the arithmetic processing unit and the video signal outputted by the bypass switching unit without performing the digital arithmetic processing. A video signal from a home video game machine or the like is bypassed from the digital arithmetic processing to reduce uncomfortable feeling caused by delay.

### CROSS-REFERENCE TO RELATED APPLICATIONS

This application is based upon and claims the benefit of priority from prior Japanese Patent Application No. 2004-159497, filed May 28, 2004, the entire contents of which are incorporated herein by reference.

### BACKGROUND OF THE INVENTION

1. Field of the Invention

The present invention relates to a display apparatus such as a television set including a flat panel display (FPD) such as a plasma display panel (PDP) and a liquid crystal display panel (LCD), and a display method. Particularly, the invention relates to a display apparatus and a display method in which a specific video signal inputted from an external device such as a home video game machine is bypassed from digital arithmetic processing to decrease processing delay time.

2. Description of the Related Art

Recently, video devices widely spread, and a user utilizes the many video devices. For example, a display apparatus such as a television set is utilized by connecting a plurality of video devices such as a video recorder, a DVD (Digital Versatile Disk) recorder, a PC (Personal Computer), and a home video game machine to the display apparatus.

As a price of an integrated circuit is decreased, the digital processing of the video signal and the audio signal advances. Correspondingly, a ratio of the digital signal processing is largely increased in the signal processing of the video device. As a result, sometimes delay is generated in the signal processing of the video signal.

In Patent Reference 1 (Jpn. Pat. Appln. KOKAI Publication No. 2001-36869), a sound delay circuit is provided in order to eliminate the delay between a video signal and an audio signal, and difference between a picture and a sound is covered by delaying the audio signal so that a delay time accompanied with a digital arithmetic processing of the video signal is practically unnoticed.

Like a broadcasting signal through a tuner, in a video signal in which a user does not feel the delay at least on the surface only by synchronizing the audio signal with the delay of the video signal, the problem of the delay can be eliminated by the method disclosed in Patent Reference 1. However, for example, the delay of an operation signal from a home video game machine connected to an external input terminal cannot be eliminated by the method disclosed in Patent Reference 1.

Namely, the video signal from the home video game machine connected to the external input terminal is passed through the same signal path as a television video signal, the digital processing is performed to the video signal, and then the video signal is displayed on the screen. Accordingly, when the video signal from the home video game machine is displayed on the screen after all the wide variety of digital arithmetic processings are ended, in one of examples, sometimes the video signal is displayed after the delays of seven fields.

Therefore, when the home video game machine or the like is operated by connecting the home video game machine to the digital television or the like, the reaction of a controller of the home video game machine is not instantly displayed on the screen and the display includes the delay while the user operates a controller of the home video game machine, so that there is a problem in that the user feels uncomfortable in the game in which a sense of speed is required.

### BRIEF SUMMARY OF THE INVENTION

An embodiment of the present invention is a display apparatus comprising: an input unit which inputs a video signal; a tuner which tunes and demodulates a broadcasting signal to output the video signal; an arithmetic processing unit which performs digital arithmetic processing to the video signal from the input unit or the tuner and outputs the processed video signal; a bypass switching unit which outputs the video signal to a subsequent stage without performing the digital arithmetic processing of the arithmetic processing unit; and a display unit which displays a picture on the basis of one of the processed video signal from the arithmetic processing unit and the video signal outputted by the bypass switching unit without performing the digital arithmetic processing.

### BRIEF DESCRIPTION OF THE SEVERAL VIEWS OF THE DRAWING

FIG. 1 is a block diagram showing a configuration of a display apparatus according to an embodiment of the invention;

FIG. 2 is a block diagram showing a configuration of a display apparatus which has a digital arithmetic processing unit with a bypass function according to the embodiment of the invention;

FIG. 3 is a block diagram showing an example of a configuration of the digital arithmetic processing unit with the bypass function according to the embodiment of the invention;

FIG. 4 is a flowchart showing an example of bypass operation of the display apparatus according to the embodiment of the invention;

FIG. 5 is a plan view showing an example of a remote-control unit of the display apparatus according to the embodiment of the invention; and

FIG. 6 is a block diagram showing a configuration of a display apparatus which has a bypass-dedicated input terminal according to the embodiment of the invention.

### DETAILED DESCRIPTION OF THE INVENTION

Referring to the accompanying drawings, an embodiment of the invention will be described in detail.

<Television Set Which is a Display Apparatus According to an Embodiment of the Invention>

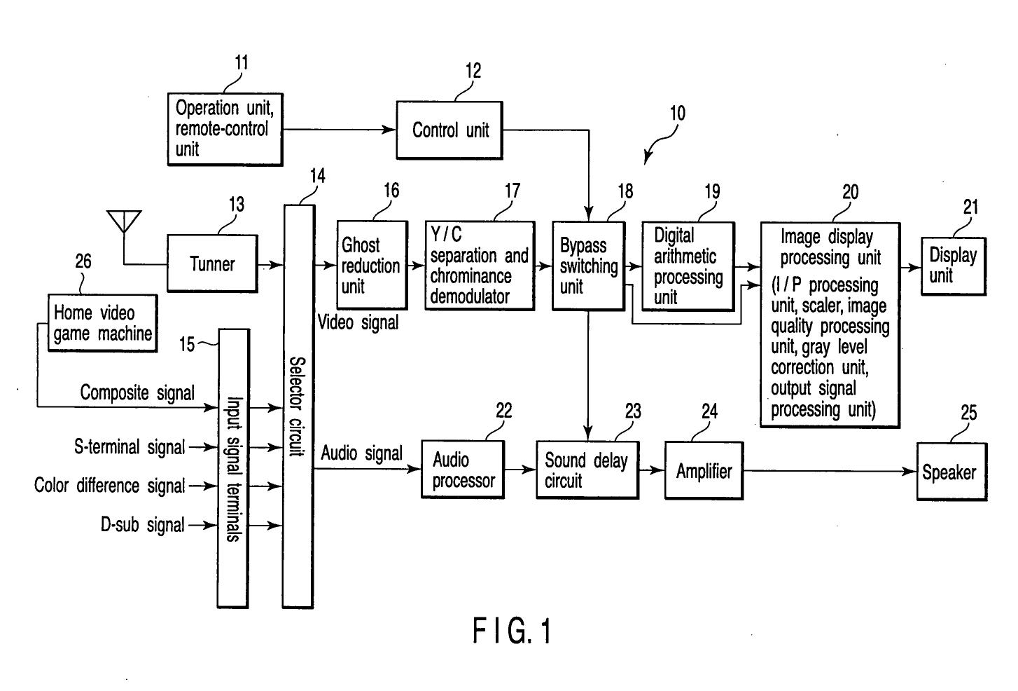

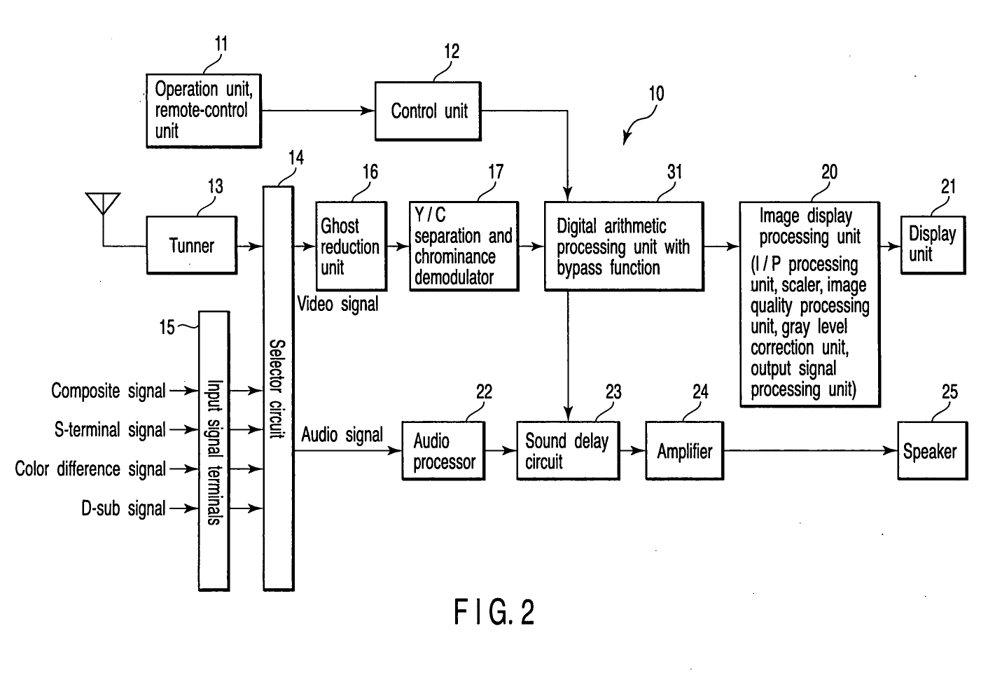

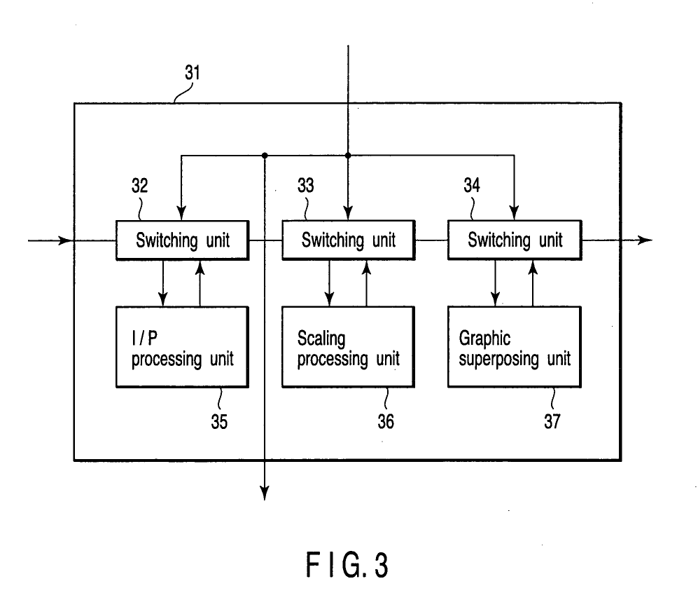

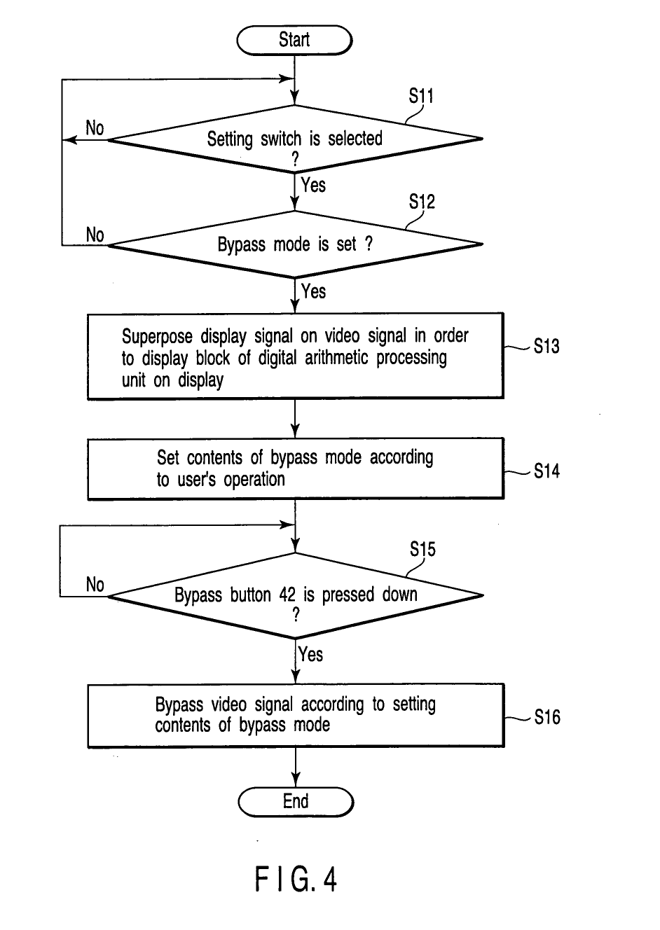

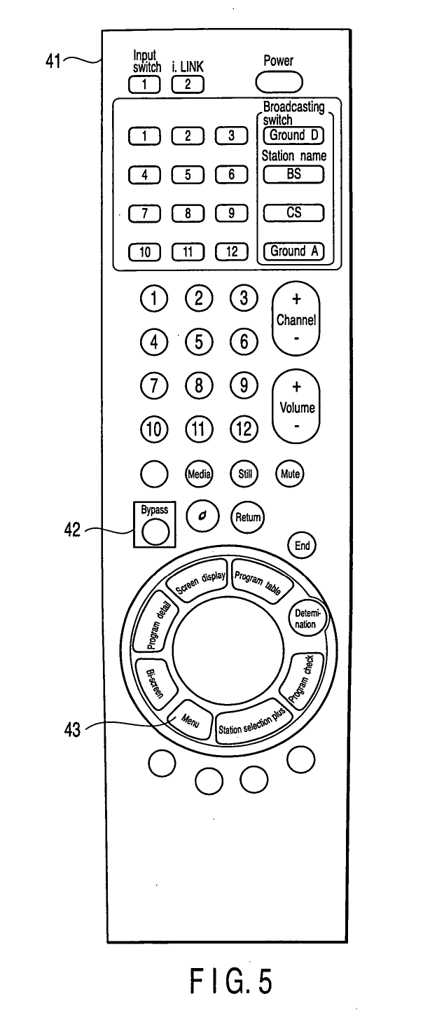

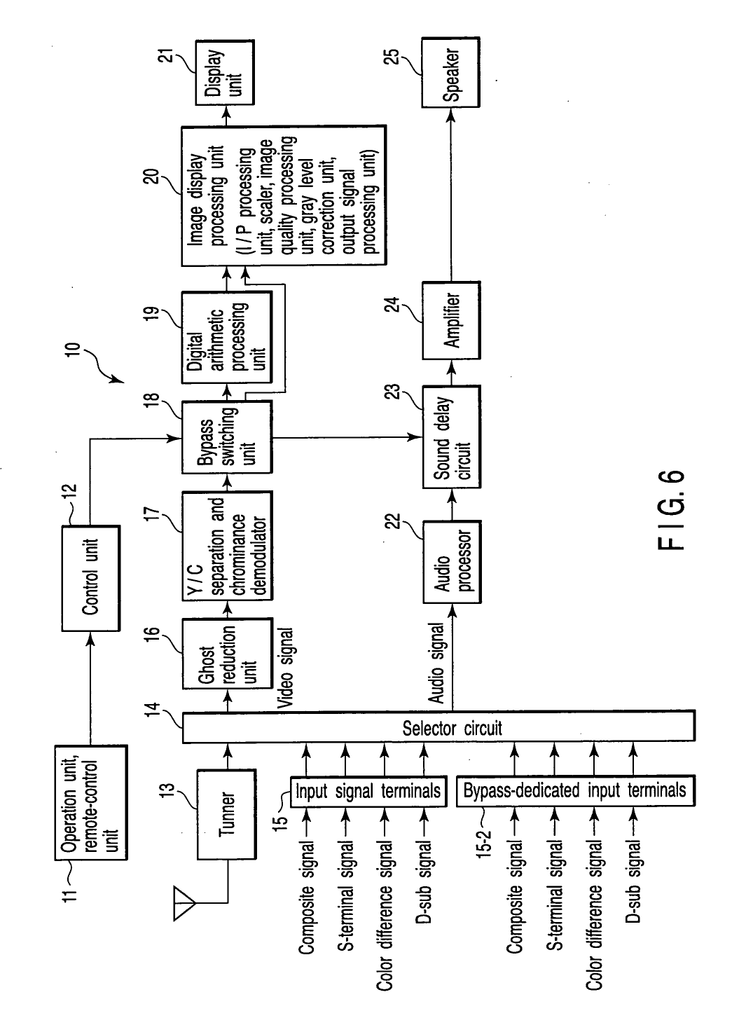

Referring to the drawings, a color television set with a tuner will be described as an embodiment of a display apparatus according to the invention. FIG. 1 is a block diagram showing a configuration of the display apparatus according to the embodiment of the invention, FIG. 2 is a block diagram showing a configuration of a display apparatus which has a digital arithmetic processing unit with a bypass function according to the embodiment of the invention, FIG. 3 is a block diagram showing an example of a configuration of the digital arithmetic processing unit with the bypass function according to the embodiment of the invention, FIG. 4 is a flowchart showing an example of bypass operation of the display apparatus according to the embodiment of the invention, FIG. 5 is a plan view showing an example of a remote-control unit of the display apparatus according to the embodiment of the invention, and FIG. 6 is a block diagram showing a configuration of a display apparatus which has a bypass-dedicated input terminal according to the embodiment of the invention.

(Configuration)

As shown in FIG. 1, a television set 10 which is the display apparatus according to the embodiment of the invention has an operation unit 11, a control unit 12, a tuner 13, a selector circuit 14, and input signal terminals 15. The operation unit 11 includes a remote-control unit 41 (see FIG. 5) and the like. The control unit 12 controls operation of the whole of television set, and an operation signal is provided from the operation unit 11 to the control unit 12. The tuner 13 tunes and demodulates a broadcasting signal to output a video signal and an audio signal. Examples of the broadcasting signal include satellite broadcasting signals such as a BS (Broadcasting Satellite) analog broadcasting signal, a BS digital broadcasting signal, and a CS (Communication Satellite) broadcasting signal, a ground wave broadcasting signal, and a ground wave digital broadcasting signal. The input signal terminals 15 receive a video signal and an audio signal which are of external inputs. The video signal and the audio signal have signal formats such as a composite signal, an S-terminal signal, a color difference signal, and a D-sub signal. The selector circuit 14 receives the video signal and the audio signal from the tuner 13 and the input signal terminals 15, and the selector circuit 14 respectively provides the video signal and the audio signal to a ghost reduction unit 16 and an audio processor 17 on the basis of operation information from the operation unit 11 or a program stored in a recording region such as a ROM and a RAM (not shown) of the control unit 12.

The television set 10 also has a Y/C separation and chrominance demodulator 17 which treats the video signal. The Y/C separation and chrominance demodulator 17 is provided at a stage subsequent to the ghost reduction unit 16. The television set 10 further has a bypass switching unit 18 subsequent to the Y/C separation and chrominance demodulator 17, and the bypass switching 18 is controlled by the control unit 12 to bypass the video signal. The television set 10 further has a digital arithmetic processing unit 19 subsequent to the bypass switching unit 18. For example, the digital arithmetic processing unit 19 performs graphic superposition, and the digital arithmetic processing unit 19 also performs I/P processing and H/V scaling according to the mode. Furthermore, the television set 10 has an image display processing unit 20 as a backend processor. The image display processing unit 20 includes an I/P processing unit, an H/V scaling unit, an image quality processing unit, a gray level correction unit, and an output signal processing unit in order to generate a video signal according to a type of a display unit 21 subsequent to the image display processing unit 20. An FPD (Flat Panel Display) such as a PDP (Plasma Display Panel) and an LCD (Liquid Crystal Display) is used as the display unit 21. However, the display unit 21 is not limited to the FPD, and a conventional cathode-ray tube can also be used.

Further, the television set 10 has an audio processor 22, a sound delay circuit unit 23, an amplifier 24, and a speaker 25. The audio processor 22 acts as a processing unit for the audio signal, and receives the audio signal provided from the selector circuit 14 to process the audio signal. The sound delay circuit unit 23 delays the audio signal according to a control signal from the control unit 12, for example, according to delay time of the video signal. The amplifier 24 is provided at the stage subsequent to the audio delay circuit unit 23, and amplifies the audio signal to a certain degree. The speaker 25 outputs sound according to the audio signal amplified by the amplifier 24.

(Operation)

In the television set 10 having the configuration described above, the tuner 13 tunes, for example, one of the digital BS broadcasting signals according to user's operation of the operation unit 11 under control of the control unit 12. The tuned broadcasting signal is then demodulated, and the video signal and the audio signal are provided to the selector circuit 14.

When the selector circuit 14 selects the video signal and the audio signal provided from the tuner 13, in the video signal, a ghost component is removed by the ghost reduction unit 16, and the Y/C separation and chrominance demodulator 17 separates a brightness and color difference signal to demodulate a color signal. Unless the bypass switching unit 18 particularly performs the bypass processing, the digital arithmetic processing unit 19 performs the graphic superposition (or performs the I/P processing and the H/V processing in some modes) to the demodulated color signal. Subsequently, the image display processing unit 20 which is a backend processor performs the I/P processing and the signal processing (the H/V scaling, the image quality processing, the gray level correction, and the like) according to the display panel. For the video signal in which the signal processing has been performed, a picture of a broadcasting tuned by the user is displayed on the display unit such as a liquid crystal display screen.

At the same time, the audio signal from the tuner 13 is inputted to the audio processor 22 through the selector circuit 14, and the audio processor performs phase adjustment and sound quality adjustment to the audio signal. After, the sound delay circuit unit 23 imparts appropriate delay time to the audio signal, the amplifier 24 amplifies the audio signal to proper sound volume, and the sound is outputted from the speaker 25 according to the broadcasting signal.

At this point, the FPD such as a PDP and an LCD has a delay element from viewpoints of characteristics. Therefore, when the FPD is used as the display unit 21, for example, about seven-field delay occurs as the whole system. However, when the user independently watches a television program, the user never notices the delay as long as the picture and the sound are synchronized with each other.

(Display Operation by Input Signal Terminal Such as Home Video Game Machine)

Then, a case in which a home video game machine 26 is connected to the input signal terminals 15 to play the game using the television set 10 as shown in FIG. 1 will be described. In this case, a video signal and an audio signal from the home video game machine 26 are provided in a form of a composite signal to the input signal terminals 15. The video signal is provided to the ghost reduction unit 16 through the selector circuit 14, and the audio signal is provided to the audio processor 22 through the selector circuit 14.

Conventionally, as with the video signal from the tuner 13, the video signal from the home video game machine 26 is provided to the display unit 21 through the digital arithmetic processing unit 19 and the image display processing unit 20. At this point, the delay of about 7 fields occurs as the whole system. Therefore, even if the user operates a controller of the home video game machine 26, the user's operation is reflected in the picture after the delay of about 7 fields, which causes the user to feel uncomfortable in the game in which a sense of speed is required.

(Bypass Processing)

On the contrary, in the television set 10 according to the embodiment of the invention, a specific video signal provided to the bypass switching unit 18 is not provided to the digital arithmetic processing unit 19, but the video signal is bypassed and provided to the subsequent-stage image display processing unit 20 which is the backend processor by the action of the control unit 12. At this point, the processing of even the video signal from the home video game machine 26 cannot be abbreviated in the image display processing unit 20 which is the backend processor. For example, the signal processing is performed in order to adapt the video signal to the display unit 21 which is a flat panel display.

Therefore, only the digital arithmetic processing which is relatively easy to bypass is abbreviated in the digital arithmetic processing unit 19, which allows, for example, the delay of four fields to be eliminated in the digital arithmetic processing unit 19 to reduce the delay time from the seven-field delay to the three-field delay as a whole. Here, a case in which the delay time of the image display processing unit 20 is about two fields and the delay time of the display unit 21 is about one field is explained as an example.

The delay time is changed by performing the bypass processing for the video signal. In the audio signal, the delay time is also adjusted by the sound delay circuit unit 23 according to the change in delay time of the video signal. Accordingly, when the delay time of the video signal is changed from the seven fields to the three fields, the control unit 12 controls the action of the sound delay circuit unit 23 so as to change the delay time of the audio signal from the seven fields to the three fields for synchronization with the video signal.

For the bypass processing in this case, the video signal is completely bypassed from the digital arithmetic processing unit 19. For example, the bypass processing is not “function-through” in which only the function of the circuit is turned off while the video signal is inputted to the digital arithmetic processing unit 19. In the case of the “function-through”, a path of the video signal is not changed and read/write processing of the video signal from/to the memory remains, so that the delay time cannot sufficiently be shortened.

(Trigger of Bypass Processing)

There are many triggers for determining whether or not the control unit 12 bypasses the video signal. A method of allocating the trigger function to the input signal terminal 15 by the setting of the operation unit 11 can be cited as an example. Namely, the control unit 12 sets the bypass switching unit 18 so that the video signal inputted from a predetermined terminal in the input signal terminals 15 is bypassed without exception to the subsequent stage, and the bypass processing for the video signal and the audio signal is performed according to the setting of the operation unit 11. Further, it is also preferable that the control unit 12 previously sets the predetermined terminal of the input signal terminals 15 in a default setting so as to be bypassed and the bypass processing is performed according to the setting.

It is possible that the video signal (audio signal) in processing is bypassed only when a bypass button 42 provided in a remote-control unit 41 shown in FIG. 5 is pressed down. It is also possible that the bypass processing is performed only when the bypass button 42 is pressed down and the specific video signal (audio signal) set by the control unit 12 is in processing.

It is possible that an object of the bypass processing includes not only the video signal of the home video game machine 26 provided from the input signal terminal 15 but also the video signal (audio signal) from the tuner 13. In this case, it is possible to bring the video signal close to sound timing of the neighboring analog television set by performing the bypass processing to the video signal (audio signal) from the tuner 13.

(Bypass in Each Digital Arithmetic Processing)

Then, a case in which the bypass is controlled in each of a plurality of digital arithmetic processings of a digital arithmetic processing unit 31 will be described referring to FIGS. 2 and 3. In the digital arithmetic processing unit 31 with bypass function of FIG. 2, as shown in FIG. 3, a bypass switching unit 32 is provided for an I/P processing unit 35, a bypass switching unit 33 is provided for a scaling processing unit 36, and a bypass switching unit 34 is provided for a graphic superposing unit 37. Thus, the bypass switch unit is provided in each of the plurality of digital arithmetic processings and the bypass switching unit is controlled point for point by the control unit 12, which results in both delay avoidance of the finer video signal and convenience because of the digital processing of the video signal. For example, for the video signal and the audio signal according to the broadcasting signal from the tuner 13, the processing which is not really necessary to perform can selectively be bypassed.

(Setting of Bypass Contents)

Then, a case in which the user arbitrarily sets contents of the bypass processing to perform the bypass processing will be described referring to a flowchart of FIG. 4. For example, the user can set the contents of the bypass processing by operating the operation unit 11 or operation switches of the remote-control unit 41 while watching a setting screen shown in the display unit 21.

In the action of an operation program stored in a storage area of a ROM or a RAM (not shown) in the control unit 12, a setting switch is further selected from a menu screen by operating the operation unit 11 or a menu button 43 of the remote-control unit 41 shown in FIG. 5 (S11), and the setting of a bypass mode is selected from the setting screen (S12). Therefore, the user can set the contents of the bypass mode from the screen.

The graphic superposing unit 37 of the digital arithmetic processing unit 19 superposes a graphic diagram similar to the block diagram of the digital arithmetic processing unit 31 shown in FIG. 3 on the original picture, and the graphic diagram superposed on the original picture is displayed in the display unit 21 (S13). The user can selectively set the bypass of only the graphic superposing unit 37 in the digital arithmetic processing unit 31 by operating the operation unit 11 or the operation button of the remote-control unit 41 (S14). The user can also set what kind of trigger to the bypass processing. For example, it is possible a video signal and an audio signal of an arbitrary input signal terminal are set to the trigger, or it is possible that the operation unit 11 or a bypass button 42 of the remote-control unit 41 is set to the trigger.

When the bypass button 42 is set to the trigger, the press-down of the bypass button 42 is detected (S15), and the bypass processing of the video signal is performed according to the setting contents of the bypass mode, for example, only the graphic superposing unit 37 is selectively bypassed (S16). Therefore, the necessary digital arithmetic processing is not bypassed, and the delay time of the whole system is shortened, so that the user's uncomfortable felling caused by the delay time of the digital arithmetic processing can be eliminated.

(Bypass-Dedicated Input Signal Terminal)

As shown in FIG. 6, it is preferable to provide a bypass-dedicated input signal terminal 15-2. In this case, specific settings are not performed to the video signal and audio signal to be connected to the bypass-dedicated input signal terminal 15-2. The video signal is bypassed from the digital arithmetic processing in the digital arithmetic processing unit 19 and provided to the subsequent stage. It is preferable to invite user's attention by displaying “home video game machine dedicated”, “home video game machine bypass terminal”, or the like in the bypass-dedicated input signal terminal 15-2. Even when the bypass processing is determined, it is preferable that the detail contents of the bypass processing are set from the setting screen.

As described above, in the display apparatus according to the embodiment of the invention, digital arithmetic processings are not performed to all the video signals unlike the video signal from the tuner. For example, unlike the video signal from the tuner, it is not always necessary that all the digital arithmetic processings are performed to the video signal from the home video game machine which is provided from the external input terminal, and some of the digital arithmetic processings can be abbreviated.

On the other hand, as cost of the digital integrated circuit is reduced, the digital arithmetic processing of the video signal which is performed in the television set or the like is enlarged in kind and scale. Therefore, when the home video game machine is operated by connecting the home video game machine or the like from the external input terminal, since the processing delay of seven fields occurs, there is the problem in that the user senses the reaction displayed on the screen slow to feel uncomfortable when the user operates the controller of the home video game machine. The invention provides the display apparatus, in which the bypass switch is provided with respect to the digital arithmetic processing to selectively bypass all or a part of the digital arithmetic processings, thereby the delay of the picture display is eliminated and the uncomfortable feeling is avoided during the operation within the range in which the defect does not occur in the picture processing.

In the invention, it is possible that the digital arithmetic processing which should be bypassed is arbitrarily set on the television screen, and it is possible that the amount of delay of the sound is automatically changed according to the setting. Further, it is possible that the bypass button is provided in the remote-control unit or the operation switch to avoid the processing delay at arbitrary timing even in the video signal not only from the home video game machine but also from the television broadcasting or other external devices.

It is understood that those skilled in the art could realize the invention by the various embodiments explained above, and it is also understood that those skilled in the art could easily make various modifications of the disclosed embodiment without departing from the spirit and scope of the invention and could apply the invention to various embodiments without any inventive ability. It is therefore understood that the invention covers a wide range which is consistent with the disclosed principles and the novel features and the invention is not limited to the above-described embodiment.

1. A display apparatus comprising:
an input unit which inputs a video signal;
a tuner which tunes and demodulates a broadcasting signal to output the video signal;
an arithmetic processing unit which performs digital arithmetic processing to the video signal from the input unit or the tuner and outputs the processed video signal;
a bypass switching unit which outputs the video signal to a subsequent stage without performing the digital arithmetic processing of the arithmetic processing unit; and
a display unit which displays a picture on the basis of one of the processed video signal from the arithmetic processing unit and the video signal outputted by the bypass switching unit without performing the digital arithmetic processing.

2. A display apparatus according to claim 1, further comprising:
a delay circuit which further receives an audio signal from the input unit or the tuner, the delay circuit delaying the audio signal to output the audio signal according to delay time by the digital arithmetic processing of the video signal which corresponds to operation of the bypass switching unit.

3. A display apparatus according to claim 1, wherein the arithmetic processing unit performs a plurality of digital arithmetic processings, the arithmetic processing unit having a plurality of bypass switches in each of the digital arithmetic processings, and selectively bypassing an arbitrary digital arithmetic processing of said plurality of digital arithmetic processings.

4. A display apparatus according to claim 1, wherein the arithmetic processing unit performs at least one digital arithmetic processing of I/P processing, scaling processing, and graphic superposing processing, the arithmetic processing unit having a plurality of bypass switches in each of the digital arithmetic processings, and selectively bypassing an arbitrary digital arithmetic processing of said plurality of digital arithmetic processings.

5. A display apparatus according to claim 1, further comprising:
a control unit in which a bypass mode is provided, the control unit setting which one of the plurality of digital arithmetic processings included in the arithmetic processing unit should be bypassed, and then controlling the bypass switch according to the setting.

6. A display apparatus according to claim 1, further comprising:
a control unit in which the bypass mode is provided, the control unit encouraging a user to set which one of the plurality of digital arithmetic processings included in the arithmetic processing unit should be bypassed by generating image information showing a block diagram of the plurality of digital arithmetic processings, and by superposing the image information on the picture information to display the image information in the display unit when the user selects the bypass mode, and then controlling the bypass switch according to the setting.

7. A display apparatus according to claim 1, wherein a bypass button is further provided on an operation switch or an operation remote-control unit, and the bypass switching unit outputs the video signal to the subsequent stage without performing the digital arithmetic processing when the bypass button is operated.

8. A display apparatus according to claim 1, wherein the input unit has a bypass-dedicated input terminal, and the bypass switching unit outputs the video signal provided from the bypass-dedicated input terminal to the subsequent stage without necessarily performing the digital arithmetic processing.

9. A display apparatus according to claim 1, wherein it is specified that a home video game machine is connected to the input unit, the input unit has a bypass-dedicated input terminal to which the video signal is inputted in at least one of signal modes of a composite signal, an S-terminal signal, a color difference signal, and a D-sub signal, and the bypass switching unit outputs the video signal provided from the bypass-dedicated input terminal to the subsequent stage without necessarily performing the digital arithmetic processing.

10. A display apparatus comprising:
an input unit which inputs a video signal;
an arithmetic processing unit which performs digital arithmetic processing to the video signal and outputs the processed video signal;
a bypass switching unit which outputs the video signal to a subsequent stage without performing the digital arithmetic processing of the arithmetic processing unit; and
a display unit which displays a picture on the basis of one of the processed video signal from the arithmetic processing unit and the video signal from the bypass switching unit.

11. A display method comprising:
inputting a video signal;
tuning and demodulating a broadcasting signal to output the video signal;
determining whether or not digital arithmetic processing is performed to the inputted video signal or to the video signal by the broadcasting signal;
performing the digital arithmetic processing to the inputted video signal or the video signal by the broadcasting signal according to the determination, or bypassing the video signal to a subsequent stage without performing the digital arithmetic processing to the video signal; and
displaying a picture on the basis of one of the video signal to which the arithmetic processing is performed and the bypassed video signal.

12. A display method according to claim 11, wherein the video signal by the input or an audio signal accompanied with the video signal by the broadcasting signal is further received, the audio signal is delayed according to delay time by the digital arithmetic processing of the video signal, and the audio signal is outputted.

13. A display method according to claim 11, wherein a plurality of digital arithmetic processings are performed to the video signal, a plurality of bypass switches are prepared in each of the digital arithmetic processings, and an arbitrary digital arithmetic processing of said plurality of digital arithmetic processings is selectively bypassed.

14. A display method according to claim 11, wherein at least one digital arithmetic processing of I/P processing, scaling processing, and graphic superposing processing is performed to the video signal, a plurality of bypass switches are prepared in each of the digital arithmetic processings, and an arbitrary digital arithmetic processing of said plurality of digital arithmetic processings is selectively bypassed.

15. A display method according to claim 11, further comprising:
preparing a bypass mode;
setting which one of said plurality of digital arithmetic processings to be performed to the video signal should be bypassed, when a user selects the bypass mode; and
bypassing the video signal to the subsequent stage according to the setting.

16. A display method according to claim 11, further comprising:
preparing a bypass mode;
encouraging the user to set which one of the plurality of digital arithmetic processings to be performed to the video signal should be bypassed, by generating image information showing a block diagram of the plurality of digital arithmetic processings and by superposing the image information on the picture information to display the image information in the display unit, when the user selects the bypass mode; and
bypassing the video signal to the subsequent stage according to the setting.

17. A display method according to claim 11, wherein a bypass button is further prepared on an operation switch or an operation remote-control unit, and the video signal is bypassed to the subsequent stage without performing the digital arithmetic processing when the bypass button is operated.

18. A display method according to claim 11, wherein a bypass-dedicated input terminal is prepared, and the video signal provided from the bypass-dedicated input terminal is bypassed to the subsequent stage without necessarily performing the digital arithmetic processing.

19. A display method according to claim 11, wherein it is specified that a home video game machine is connected to the input unit, a bypass-dedicated input terminal to which the video signal is inputted in at least one of signal modes of a composite signal, an S-terminal signal, a color difference signal, and a D-sub signal is prepared, and the video signal provided from the bypass-dedicated input terminal is bypassed to the subsequent stage without necessarily performing the digital arithmetic processing.

20. A display method comprising:
inputting a video signal;
determining whether or not digital arithmetic processing is performed to the video signal;
performing the digital arithmetic processing to the video signal according to the determination, or bypassing the video signal to a subsequent stage without performing the digital arithmetic processing to the video signal; and
displaying a picture on the basis of one of the video signal to which the arithmetic processing is performed and the bypassed video signal.
